(19) United States
(12) Patent Application Publication
(10) Pub. No.: US 2015/0312113 A1
(43) Pub. Date: Oct. 29, 2015

(54) AllJoyn Messaging Anonymous Targets Based on Association

(71) Applicant: QUALCOMM Incorporated, San Diego, CA (US)

(72) Inventors: Babak Forutanpour, Carlsbad, CA (US); Hang Dong, La Jolla, CA (US); Richard Oliver Farley, San Diego, CA (US); David Louis Bednar, San Diego, CA (US)

(21) Appl. No.: 14/638,520

(22) Filed: Mar. 4, 2015

Related U.S. Application Data
(60) Provisional application No. 61/984,904, filed on Apr. 28, 2014.

(51) Int. Cl. H04L 12/26; H04L 12/24; G06F 3/0484; H04L 29/08; H04W 8/00; H04W 4/02

(52) U.S. Cl. CPC H04L 43/045; H04W 8/005; H04W 4/023; G06F 3/04847; G06F 3/04842; H04L 67/10; H04L 67/16; H04L 41/12

(57) ABSTRACT

Various embodiments provide methods implemented by a requesting device and a responding device for collectively identifying one or more clusters of nearby computing devices by collaborating and sharing information. In various embodiments, the requesting device may send a distance threshold to responding devices, along with a request for grouping information about computing devices that are within the distance threshold of the responding devices. In response to receiving the request and distance threshold, each responding device may identify a number of other computing devices that are within the distance threshold and may send such information to the requesting device. The requesting device may identify one or more clusters of computing devices based on the received grouping information. By configuring responding devices to detect other computing devices within a modifiable distance threshold, the requesting device may dynamically adjust the size of identified clusters of computing devices.

### CROSS REFERENCE TO RELATED APPLICATIONS

This application claims the benefit of priority to U.S. Provisional Patent Application No. 61/984,904 entitled “AllJoyn Messaging Anonymous Targets Based on Association” filed Apr. 28, 2014, the entire contents of which are incorporated herein by reference.

### BACKGROUND

Currently, mobile computing devices may publically communicate with other devices over short-range communication channels by installing/executing a communication application, such as Qualcomm's AllJoyn®, that enables the device to recognize and communicate with other compatible devices (e.g., other mobile computing devices, appliances, etc. executing the AllJoyn® client). Over such device-to-device communication links, the connected devices are able to share resources and status information with those other devices regardless of the respective devices' brands, operating systems, and configurations. Further, such devices may independently communicate with each other without registering with or receiving assistance from a network.

### SUMMARY

Various embodiments provide methods, devices, and non-transitory processor-readable storage media for identifying a cluster of computing devices by a requesting device. Some embodiment methods may include determining, on the requesting device, a distance threshold for defining a cluster, and sending the distance threshold and a request for grouping information from the requesting device to a responding device. In such embodiments, the method may further include receiving, on the requesting device, grouping information from the responding device indicating a number of computing devices within the distance threshold of the responding device, and identifying, on the requesting device, a cluster of computing devices based on the received grouping information.

In some embodiments, the method may further include presenting a display of the cluster of computing devices on a display screen of the requesting device. In such embodiments, presenting a display of the cluster of computing devices on a display screen of the requesting device may further include determining a filtering criterion, filtering computing devices within the identified cluster of computing devices based on the determined filtering criterion, and presenting a display on the display screen of the requesting device that includes only the filtered computing devices. In some embodiments, the method may further include receiving a user input selection of the cluster of computing devices and sending a communication to each computing device within the selected cluster of computing devices. In such embodiments, sending a communication to each computing device within the selected cluster of computing devices may further include sending a request to each computing device within the selected cluster of computing devices to perform a coordinated action.

In some embodiments, the method may further include receiving, on the requesting device, descriptive information from the responding device describing the number of computing devices within the distance threshold of the responding device, where identifying, on the requesting device, a cluster of computing devices based on the received grouping information comprises identifying the cluster of computing devices based on the grouping information and the descriptive information. In such embodiments, the method may further include presenting a display on a display screen of the requesting device of the cluster of computing devices based on the descriptive information.

Various additional embodiments provide methods, devices, and non-transitory processor-readable storage media for identifying nearby computing devices by a responding device. Some embodiment methods may include receiving, on the responding device, a distance threshold from a requesting device, identifying, on the responding device, any computing devices within the distance threshold of the responding device, and sending to the requesting device information regarding identified computing devices within the distance threshold of the responding device.

In some embodiments, sending to the requesting device information regarding identified computing devices within the distance threshold of the responding device may further include generating, on the responding device, grouping information indicating a number of computing devices within the distance threshold of the responding device, and sending the grouping information from the responding device to the requesting device. In some embodiments, the method may further include requesting, on the responding device, descriptive information from the identified computing devices within the distance threshold of the responding device, receiving, on the responding device, the descriptive information from the identified computing devices, and sending the received description information from the responding device to the requesting device.

Various embodiments may include a computing device configured with processor-executable instructions to perform operations of the methods described above.

Various embodiments may include non-transitory processor-readable media on which is stored processor-executable instructions configured to cause a processor of a mobile communication device to perform operations of the methods described above.

Various embodiments may include a computing device having means for performing functions of the operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of networks suitable for use with various embodiments.

FIG. 2 is a component block diagram of a computing device according to various embodiments.

FIGS. 3A-3C are system block diagrams illustrating examples of a requesting device configured to identify clusters of computing devices based on information received from one or more responding devices according to various embodiments.

FIG. 4 is a process flow diagram illustrating a method for determining on a requesting device a cluster of computing devices within a distance threshold of a responding device based on grouping information received from the responding device according to various embodiments.

FIG. 5 is a process flow diagram illustrating a method for determining on a requesting device a cluster of computing devices based at least in part on information received from the responding device describing characteristics of computing devices within a distance threshold of a responding device according to various embodiments.

FIG. 6 is a process flow diagram illustrating a method for filtering a cluster of computing devices displayed on a requesting device according to various embodiments.

FIG. 7 is a process flow diagram illustrating a method for sending a coordinated action to each member of a cluster of computing devices according to various embodiments.

FIG. 8 is a process flow diagram illustrating a method for responding to a request from a requesting device for grouping information according to various embodiments.

FIG. 9 is a component block diagram of a computing device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “computing device” refers to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar electronic devices that include a programmable processor, memory, and circuitry for connecting with other electronic devices. The various aspects may be useful in mobile computing devices, such as smart phones, and so such devices are referred to in the descriptions of various embodiments.

A computing device may utilize a communication application (e.g., AllJoyn®) to communicate with other computing devices executing the same application. However, a user of such a mobile computing device may encounter situations in which the user desires to communicate with a group of devices (or the users of those devices) despite lacking the contact information or identification credentials for members of that group. For example, the user may wish to message the devices of a group of people occupying a conference room to remind them that the user is scheduled to use that room in a few minutes without having to open the door and rudely interrupt their meeting. In another example, the user may wish to message people at a social gathering, but may not know or remember their contact information.

Some solutions currently exist for enabling a user of a computing device (a “first” computing device) to communicate with groups of nearby devices despite lacking specific contact information for those devices. In these solutions, the first computing device requests information about nearby devices from a second computing device. In response, the second computing device calculates signal strengths from nearby computing devices (e.g., a “third” computing device, “fourth” computing device, etc.) and communicates these calculated signal strengths to the first computing device. In the first computing device, the relative locations of the second computing device and the other nearby computing devices may be calculated based on the received signal strength information, and the relative locations/representations of the second, third, etc. computing devices may be displayed graphically on the first computing device as one or more groups. The user of the first computing device may then make a selection of a displayed group of devices and may send a message to members of the selected group.

While current solutions enable a user's computing device to identify nearby groups of computing devices, these solutions do not presently allow the user to control the distance at which the second computing device looks for and identifies other computing device. For example, while a user may only be interested in messaging the computing devices of a few people sitting together in a restaurant, the user's computing device may instead generate and display a group of computing devices for the entire restaurant, thereby frustrating the user's ability to send directed messages to only those few people.

To overcome such disadvantages of current systems, in various embodiments, a first computing device (also referred to as a “requesting device”) may send a configurable distance threshold (e.g., a certain signal strength value) to a second computing device (also referred to as a “responding device”) and may request that the responding device identify only those computing devices that are within that configurable distance threshold rather than receiving reports of computing devices within an arbitrary distance of the responding device as performed in conventional computing devices. As a result, the requesting device may adjust the sizes of groups reported by the responding device by adjusting the distance threshold.

In conventional solutions, because only the relative locations of computing devices are determined based on their respective signal strength measurements, the user must guess the actual identities of the members of a group of computing devices displayed on the user's computing device, such as by matching the displayed group of devices with the devices the user actually sees in front of him/her, which may be difficult in situations in which multiple devices or multiple groups of computing devices are in the area.

To overcome such disadvantages of current systems, the various embodiments enable the user's requesting device to request and receive various descriptive information (e.g., sensor, location, and status information) of the members of the group of computing devices in order to make more accurate location determinations, thereby making it easier for the user to discern the identify of one or more computing devices to which the user desires to send a message.

In overview, various embodiments provide methods implemented by a requesting device and a responding device for collectively identifying one or more clusters of nearby computing devices by collaborating and sharing information. Specifically, in various embodiments, the requesting device may send a message specifying a distance threshold (e.g., received as user input) to one or more nearby responding devices, along with a request for grouping information about computing devices that are within the distance threshold of each responding device. In response to receiving the request and the distance threshold, each responding device may identify other computing devices that are within the distance threshold and may send such information to the requesting device. The requesting device may use the information received from the responding devices to identify one or more clusters of computing devices based on the received grouping information. By signaling the one or more responding devices with adjusted distance thresholds, the requesting device may dynamically adjust the size of identified clusters of computing devices that it is able to generate from responses received from the responding devices, thereby providing the user of the requesting device with a greater ability to identify and communicate with computing devices in a cluster of an appropriate or desired size despite lacking contact information for the devices in that cluster.

In various embodiments, the computing devices (e.g., the requesting device and one or more responding devices) may communicate with each other via a common or compatible communication/messaging application, such as AllJoyn® by Qualcomm® In some embodiments, the common communication/messaging application may be a software/API layer executing on top of various communication protocols, such as Bluetooth®, that may enable sending messages and commands from one computing device to another via a public port. The common communication/messaging application may be received and installed from a third party, such as an application store (e.g., Apple®'s App Store®). In other embodiments, the common communication/messaging application may be preinstalled on the computing devices by their respective original equipment manufacturers. By sharing the capability to send and receive messages to each other via the common communication application, the computing devices may exchange information regardless of their respective models, capabilities, and device types (e.g., a smart phone versus a home appliance).

In various embodiments, in response to receiving a distance threshold from a requesting device, a responding device may use the communication/messaging application to identify one or more computing devices within the distance threshold of the responding computing device. The distance threshold may be a value corresponding to a particular receiver signal strength indication (RSSI) value, an antenna gain, a distance as determined by GPS coordinates, etc. The responding device may identify the one or more computing within the distance threshold value based on the type of distance threshold (e.g., identifying all computing devices with associated RSSI values higher than the received distance threshold value).

In various embodiments, the responding device may generate grouping information of one or more computing devices detected to be within the distance threshold of the responding device and may send this grouping information to the requesting device to enable the requesting device to identify one or more clusters of computing devices. For example, the responding device may inform the requesting device that four computing devices are within the distance threshold, excluding the requesting computing device. In response, the requesting device may determine that one cluster of four computing devices (excluding the requesting device) is nearby.

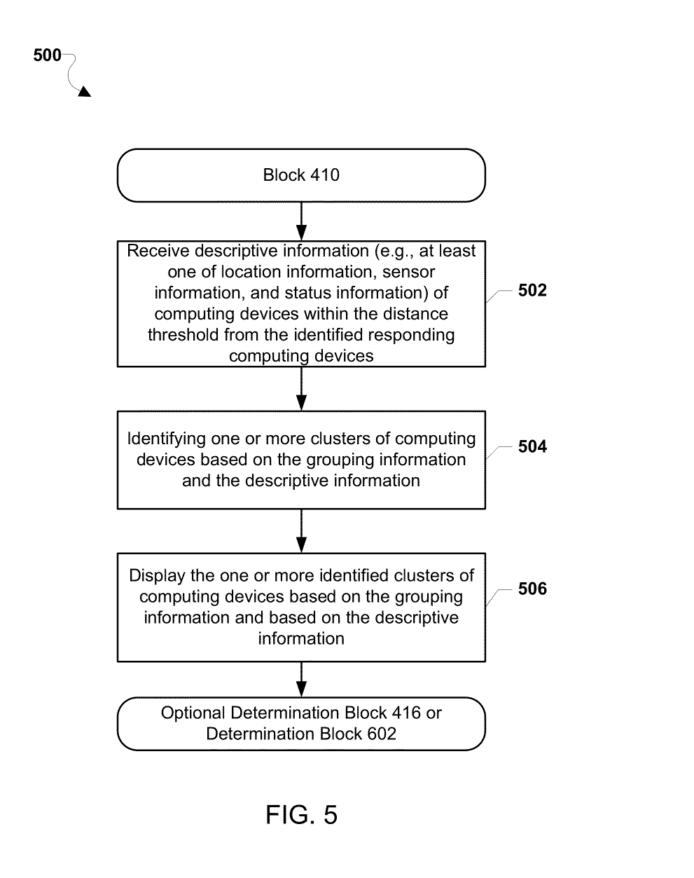

In some embodiments, the responding device may acquire various types of information related to the one or more computing device within the distance threshold. For example, such descriptive information may include at least one of location information, sensor information, and status information for the identified computing devices within the distance threshold (which may include the requesting and/or responding devices). The location information may describe the position, velocity, and/or movement characteristics of the identified computing devices, such as global positioning system (GPS) coordinate data, compass direction readings, accelerometer data, gyroscopic information, etc. The sensor information may include measurements and readings from a variety of sensors that may be installed on the identified computing devices, such as light-intensity meters and/or cameras. The status information may include other types of information that may assist a user of the requesting device to visually identify a computing device and may include a wide range of information, such as whether the computing device is engaged in an active voice call or an Internet/data session, the model/device-type of the computing device, etc. Collectively, these types of information and various other information that related to nearby computing devices may be referred to herein as “descriptive information,” and the requesting device may utilize such descriptive information to identify nearby computing devices and/or to determine the computing devices that belong to the same cluster of computing devices (e.g., as described with reference to FIG. 5), as well as other uses.

In some embodiments, in response to identifying one or more clusters of computing devices based on grouping information received from at least one responding device, the requesting device may display the one or more identified clusters on the requesting device's display. In some particular embodiments in which the requesting device has received descriptive information for members of the one or more clusters of computing devices, the requesting device may incorporate the descriptive information into the clusters of computing devices displayed to the user. In this manner the requesting device may provide the user with additional information that may help the user visually identify the members of each cluster, such as by matching each cluster of devices displayed on the requesting device's screen with the device the user sees in the vicinity.

In some embodiments, the requesting device may receive a selection of one of the displayed clusters (e.g., as a user input selection) and may send a message, command, and/or any other form of communication to the computing devices of the selected cluster. In further embodiments, the requesting device may send a coordinated action or command to each computing device of the selected cluster, which may configure each member to perform an action simultaneously. For example, in response to receiving a selection of a cluster of computing devices in a conference room, the requesting device may send a coordinated command to each member of the selected group to vibrate and display a message informing each member's user that their scheduled time in the conference room has expired.

In some embodiments, the requesting device may selectively display computing devices in a cluster based on one or more filtering criteria. By filtering the computing devices that are displayed, the requesting device may remove computing devices that may be irrelevant to the user's intended purposes. For example, in the event its user is attempting to message another person's smart phone, the requesting device may receive a filtering criterion as a user input that indicates that only smart phone devices may be displayed (in contrast to other types of devices, such as home appliances), thereby enabling a user to quickly identify the cluster of computing devices to which the other person's smart phone belongs and initiate sending a message to that cluster as described above.

For ease of reference, a computing device requesting grouping information and/or descriptive information regarding one or more computing devices within a distance threshold is referred to herein as the “requesting device,” and the computing device receiving the request from the requesting device is referred to as the “responding device.” Also for ease of reference, a requesting device may be referred to as a “first device” or “first computing device,” while a responding device may be referred to as a “second device” or “second computing device.” However, these references are merely for ease of description and are not intended to imply or require a particular computing device to be the responding device or the requesting device. For example, in some embodiments, a requesting device may at some later time become a responding computing device in response to receiving a request for grouping information from another requesting device.

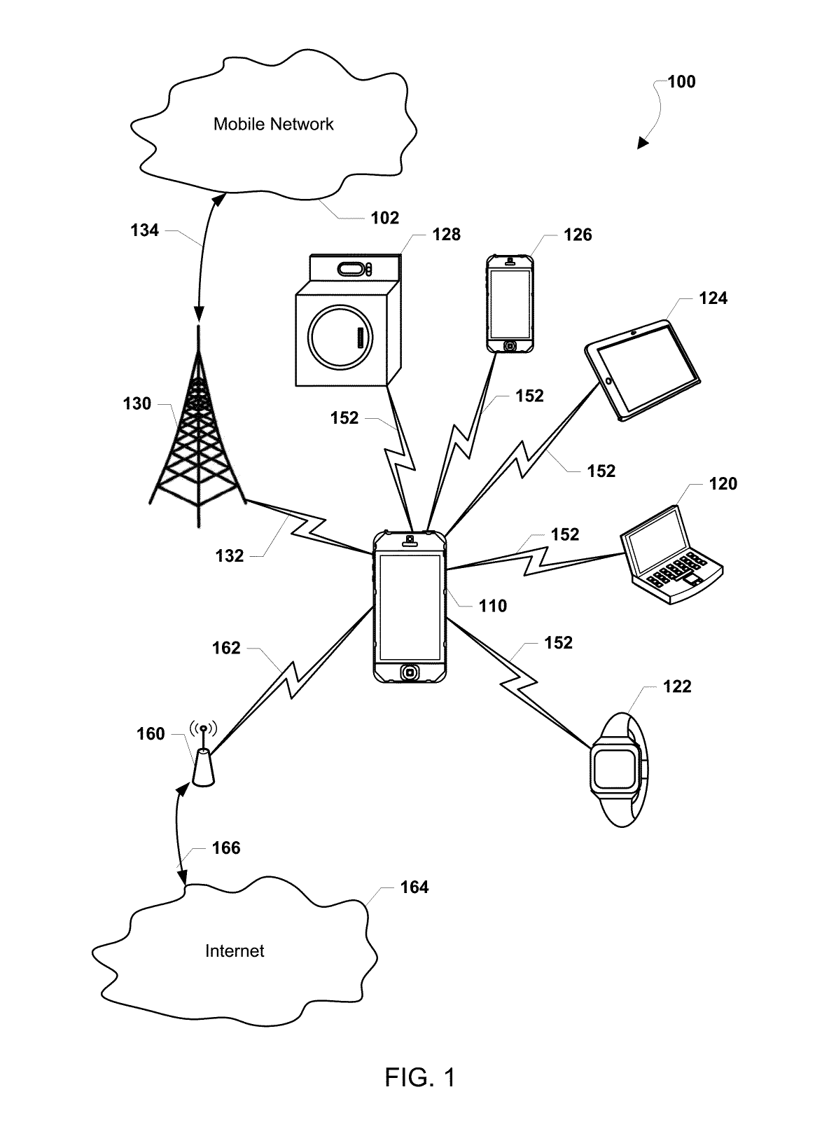

Various embodiments may be implemented within a variety of communication systems 100, an example of which is illustrated in FIG. 1. A mobile network 102 typically includes a plurality of cellular base stations (e.g., a base station 130). A computing device 110 may be in communication with the mobile network 102 through a cellular connection 132 to the base station 130. The cellular connection 132 may be made through two-way wireless communication links, such as 4G, 3G, CDMA, TDMA, WCDMA, GSM, and other mobile telephony communication technologies. The base station 130 may be in communication with the mobile network 102 over a wired connection 134. While the computing device 110 is shown connected to the mobile network 102, in some embodiments (not shown), the computing device 110 may include two or more subscriptions to two or more mobile networks and may connect to those subscriptions in a manner similar to those described above.

In some embodiments, the computing device 110 may establish a wireless connection 162 with a wireless access point 160, such as over a Wi-Fi connection. The wireless access point 160 may be configured to connect to the Internet 164 or another network over a wired connection 166.

In various embodiments, the computing device 110 may establish a wireless connection 152 (e.g., a Bluetooth®, Wi-Fi Direct®, or another near-field/short-range communication connection) with various other computing devices 120-128 via a common communication application (e.g., AllJoyn® by Qualcomm®). For example, the computing device 110 may exchange information and communications with one or more of a laptop device 120, a personal computing device 122, a tablet computing device 124, a mobile computing device 126 (e.g., a smart phone), and an appliance device 128 (e.g., a “smart” washing machine) The computing device 110 may also (or alternatively) connect to various other computing devices (not shown) that are able to communicate via the common communication application.

Further, in some embodiments (not shown), the computing devices 120-128 may establish wireless connections with each other through the common communication application.

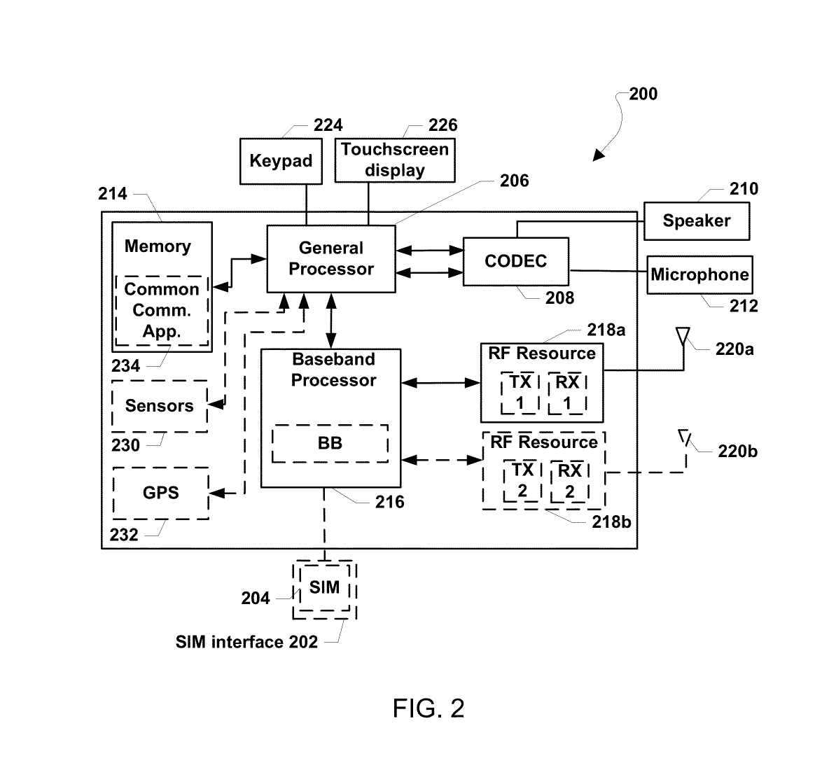

FIG. 2 is a functional block diagram of a computing device 200 suitable for implementing various embodiments. According to various embodiments, the computing device 200 may be similar to the computing device 110 as described with reference to FIG. 1.

With reference to FIGS. 1-2, the computing device 200 may optionally include a SIM interface 202, which may receive a first identity module SIM 204 that is associated with a subscription. A SIM in various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits.

The computing device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to the memory 214. The memory 214 may be a non-transitory computer readable storage medium that stores processor-executable instructions. For example, the instructions may include routing communication data relating to a SIM/subscription though a corresponding baseband-RF resource chain.

The memory 214 may store an operating system (OS), as well as user application software and executable instructions. The memory 214 may also store application data, such as an array data structure.

The general purpose processor 206 and the memory 214 may each be coupled to at least one baseband modem processor 216. Each SIM in the computing device 200 (e.g., the SIM 204) may be associated with a baseband-RF resource chain. A baseband-RF resource chain may include the baseband modem processor 216, which may perform baseband/modem functions for communicating with/controlling a radio access technology (RAT), and may include one or more amplifiers and radios, referred to generally herein as “RF resources.” In some embodiments, baseband-RF resource chains may share the baseband modem processor 216 (i.e., a single device that performs baseband/modem functions for all RATs on the computing device 200). In other embodiments, each baseband-RF resource chain may include physically or logically separate baseband processors (e.g., BB).

In some embodiments, an RF resource 218a and, optionally, an RF resource 218b may be associated with different wireless communication protocols. For example, the RF resource 218a may be associated with and enable communications via a GSM RAT, and the RF resource 218b may be associated with and enable communications with a Bluetooth® RAT. The RF resources 218a, 218b may each be transceivers that perform transmit/receive functions on behalf of their respective RATs. The RF resources 218a, 218b may also include separate transmit and receive circuitry, or may include a transceiver that combines transmitter and receiver functions. The RF resources 218a, 218b may each be coupled to a wireless antenna (e.g., a first wireless antenna 220a or, optionally, a second wireless antenna 220b). The RF resources 218a, 218b may also be coupled to the baseband modem processor 216.

In some embodiments, the general purpose processor 206, the memory 214, the baseband processor(s) 216, and the RF resources 218a, 218b may be included in the computing device 200 as a system-on-chip. In some embodiments, the SIM 204 and its corresponding interface 202 may be external to the system-on-chip. Further, various input and output devices may be coupled to components on the system-on-chip, such as interfaces or controllers. Example user input components suitable for use in the computing device 200 may include, but are not limited to, a keypad 224, a touchscreen display 226, and the microphone 212.

In some embodiments, the keypad 224, the touchscreen display 226, the microphone 212, or a combination thereof, may perform the function of receiving a user input to initiate communications with another computing device. For example, the touchscreen display 226 may receive a selection of a contact from a contact list or receive a telephone number. In another example, either or both of the touchscreen display 226 and the microphone 212 may perform the function of receiving a request to initiate an outgoing call and/or communications with another computing device. In an example, the request to initiate the communication session with another computing device may be in the form of a voice command received via the microphone 212. Interfaces may be provided between the various software modules and functions in the computing device 200 to enable communication between them, as is known in the art.

In some embodiments, the computing device 200 may include a common communication application 234 that may enable the computing device 200 to communicate with other computing devices running a copy of the common communication application 234 (e.g., Aljoyn®). The common communication application 234 may be a software program or collection of APIs stored in the memory 214 and executed by the general purpose processor 206. Via the common communication application 234, the general purpose processor 206 may send and receive requests for grouping information, distance threshold values, and/or other descriptive information to enable the computing device 200 or another device (i.e., a requesting device) to identify one or more nearby clusters of computing devices.

In some embodiments, the computing device 200 may include various sensors 230 that may be useful in determining the computing device 200's location and movement. For example, the sensors 230 may include a camera, a gyroscope, an accelerometer, a light-sensor, etc. The computing device 200 may also optionally include a GPS receiver unit 232 that may be used to receive/determine the GPS coordinates of the computing device 200, for example, by receiving GPS signals from a satellite via the RF resource 218b and the second wireless antenna 220b. In some particular embodiments, information regarding the computing device 200's location, other sensor information, and/or status (i.e., descriptive information) may be exchanged with other computing devices with the common communication application 234 via the RF resource 218a or 218b.

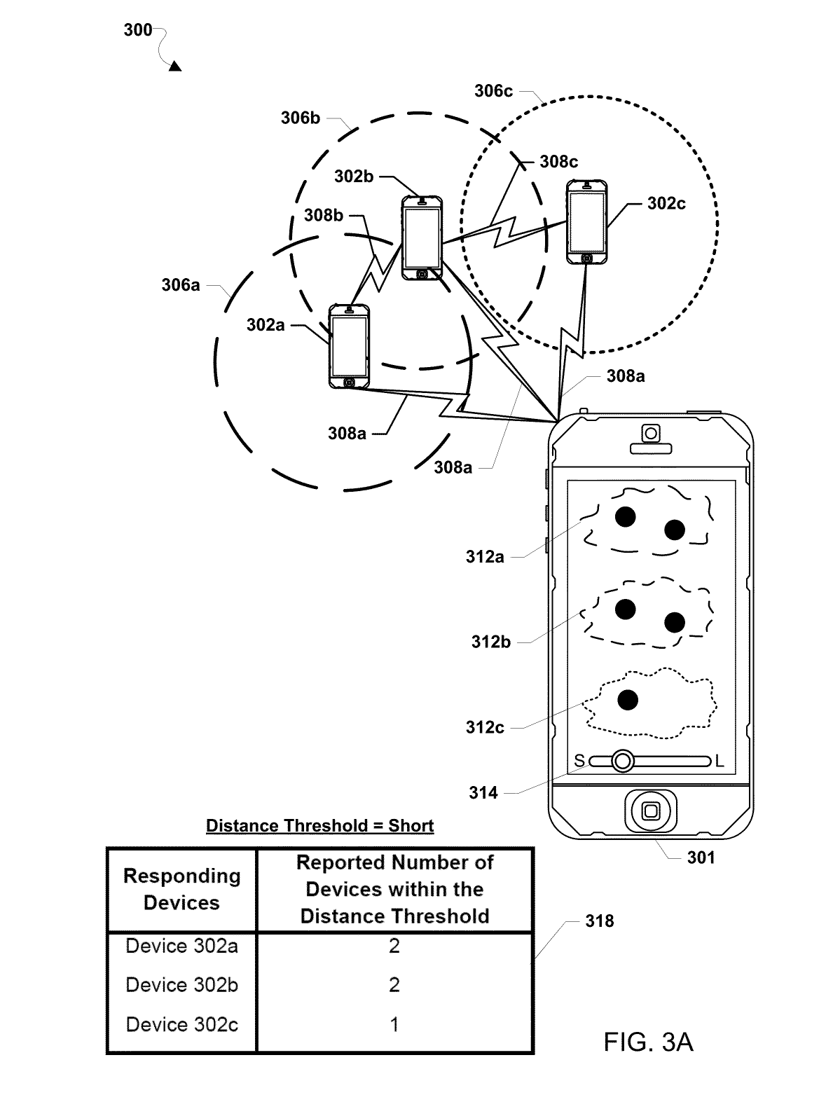

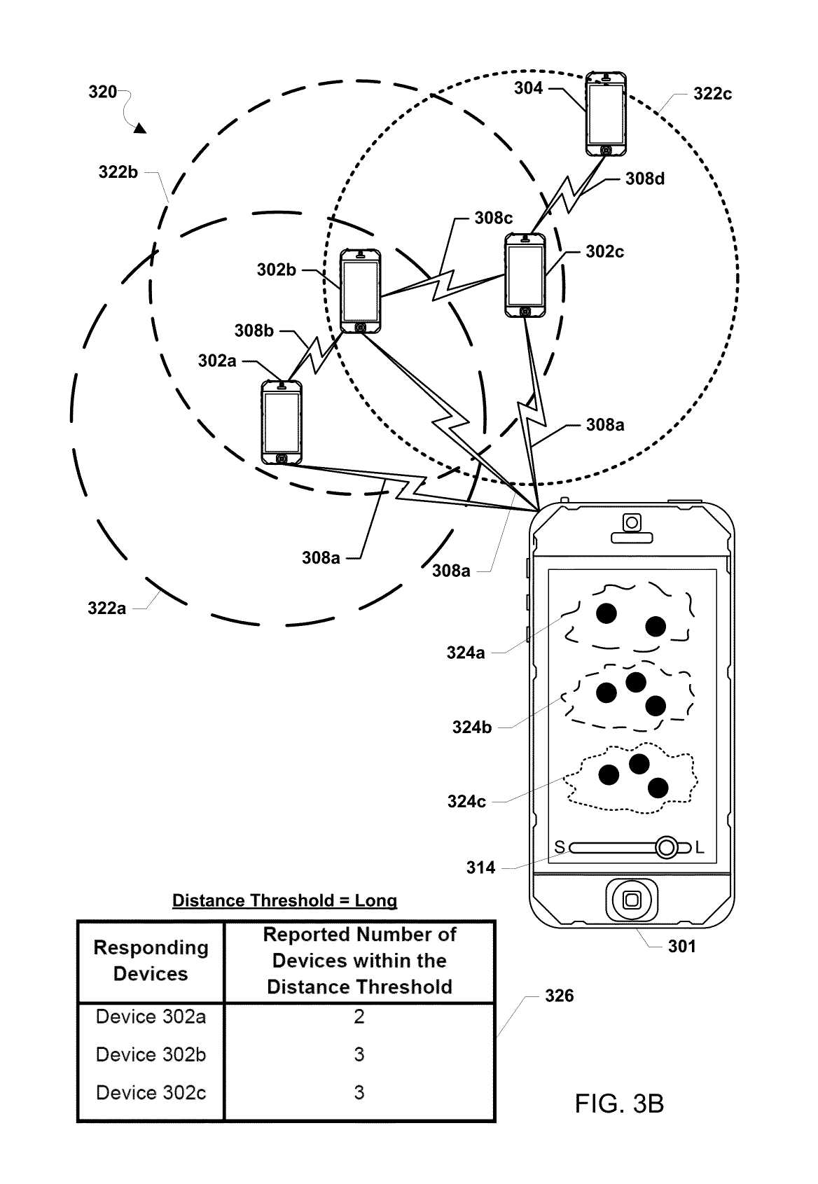

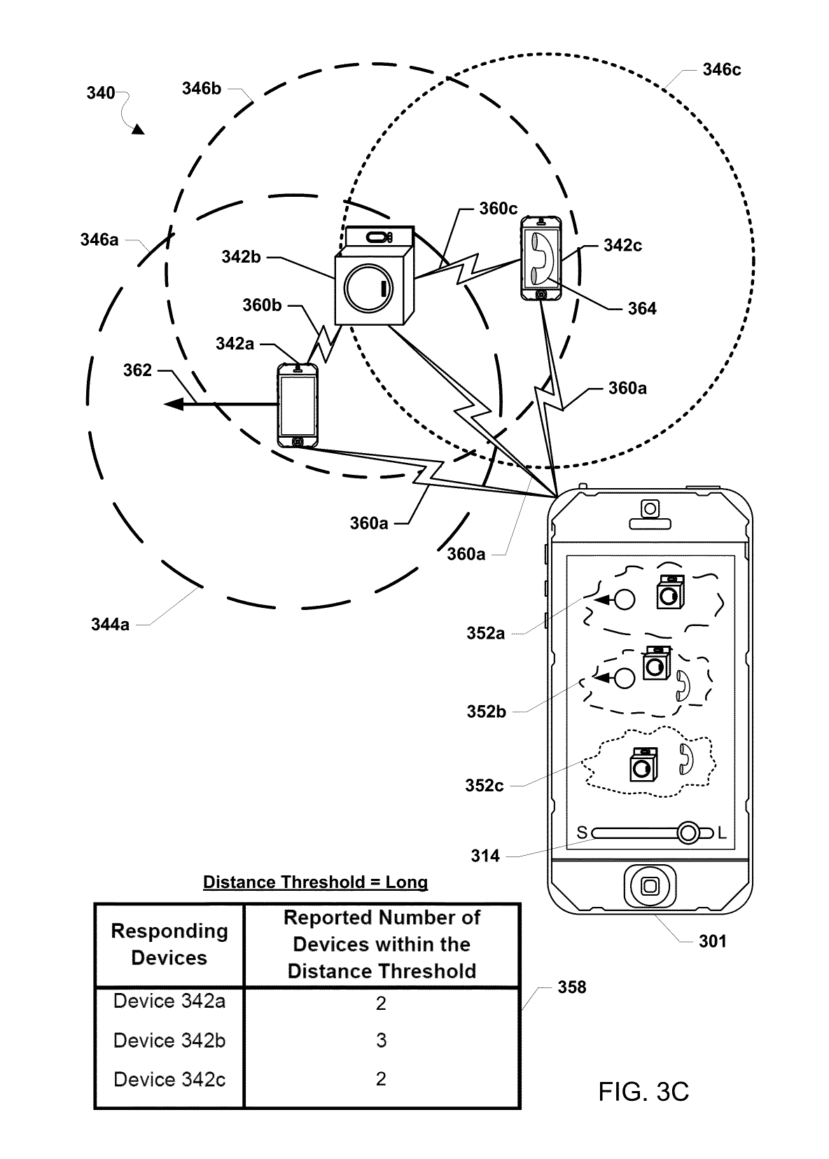

FIGS. 3A-3C illustrate example systems of computing devices (e.g., the computing devices 110, 120-128, 200 of FIGS. 1-2) communicating with each other via a common communication application (e.g., the common communication application 234) to collectively determine one or more clusters of computing devices according to various embodiments.

FIG. 3A illustrates an example system 300 in which a requesting device 301 requests, from responding devices 302a-302c, grouping information of nearby devices that are within a relatively short distance threshold of the responding devices 302a-302c, respectively. The requesting device 301 may determine a distance threshold indicating a certain distance value. In some embodiments, the distance threshold may be expressed, for example, as a minimum RSSI value, a maximum Bluetooth® antenna gain, and/or as a minimum spatial distance as determined by GPS coordinates. The requesting device 301 may determine the distance threshold based on a position of a slider input interface 314 that may be adjusted by a user of the requesting device.

The requesting device 301 may send a request for grouping information and the determined distance threshold to the responding devices 302a-302c via wireless connections 308a. The requesting device 301 may send the determined distance threshold to the responding devices 302a-302c either as part of the request for grouping information or as part of a separate communication. In some embodiments, the responding devices 302a-302c may be within a certain range (e.g., a maximum, minimum, or other predetermined range) of communications sent from the requesting device 301. In such embodiments, the requesting device 301 may send the distance threshold and request for grouping information to any computing device within the certain communication range.

In some embodiments, the computing devices 301, 302a-302c may utilize the same common communication application (e.g., the common communication application 234), thereby enabling the requesting device 301 to communicate with the responding devices 302a-302c without knowing their specific contact information, such as by sending a request for grouping information to a public port on each of the responding devices 302a-302c configured to receive communications via the common communication application.

In response to receiving the request for grouping information and the determined distance threshold value from the requesting device 301, each of the responding devices 302a-302c may identify computing devices in their respective vicinities that are within the distance threshold value. For ease of description, the distance threshold is represented in the example illustrated in FIG. 3A as perimeters 306a-306c around each of the responding devices 302a-302c, and a computing device is within the distance threshold of one of the responding devices 302a-302c when that computing device is inside the perimeters 306a-306c.

A first responding device 302a may receive signals and/or communicate with a second responding device 302b via a wireless connection 308b. Based on information received from the second responding device 302b, the first responding device 302a may determine that the second responding device 302b is within the distance threshold of the first responding device 302a (i.e., within the perimeter 306a). For example, the first responding device 302a may measure the RSSI value associated with the second responding device 302b and may compare the measured RSSI value with the RSSI value associated with the distance threshold to determine that the second responding device 302b is closer than the distance threshold. As a result, the first responding device 302a may report to the requesting device 301, via the wireless connection 308a, that there is a total of two computing devices (i.e., the first and second responding devices 302a, 302b) within the distance threshold. In some embodiments, the responding devices 302a-302c may not include the requesting device 301 in the computing devices determined to be within a distance threshold.

Similarly, the second responding device 302b may determine that the first responding device 302a is closer than the distance threshold value (i.e., within the perimeter 306b) based on the signals/communications received from the first responding device 302a via the wireless connection 308b. However, the second responding device 302b may determine that a third responding device 302c is farther away than the distance threshold value (i.e. outside the perimeter 306c) based on signals/communications received from the third responding device 302c via the wireless connection 308c. Thus, the second responding device 302b may report to the requesting device 301 via the wireless connection 308a that two computing devices (i.e., the first and second responding devices 302a, 302b) are within the distance threshold, while not reporting the third responding device 302c even though it is aware of its presence.

As there are no other computing devices within the distance threshold of the third responding device 302c (i.e., within the perimeter 306c), the third responding device 302c may report to the requesting device 301 via the wireless connection 308a that only one computing device (i.e., itself) is within the distance threshold.

In response to receiving grouping information from each of the responding devices 302a-302c (summarized in a table 318), the requesting device 301 may determine that there are three distinct clusters of computing devices nearby: a first cluster 312a of two computing devices as reported by the first responding device 302a, a second cluster 312b of two computing devices as reported by the second responding device 302b, and a third cluster 312c of one computing device as reported by the third responding device 302c.

The requesting device 301 may display the clusters 312a-312c on a display panel (e.g., the touchscreen display 226). In some embodiments, the orientation and arrangement of computing devices within each of the clusters 312a-312c may be arbitrary or may reflect the devices' relative positions. In other embodiments in which the requesting device 301 receives various location, status, and sensor information from the responding devices 302a-302c (e.g., as described with reference to FIG. 3C), the requesting device 301 may display the devices included in the clusters 312a-312c in a manner that reflects the devices' actual or relative locations, and/or the requesting device 301 may display the received information in various other configurations/orientations that may assist the user to visually match the displayed clusters with the computing devices the user sees in the area. In some embodiments, the requesting device 301 may receive information identifying individual members of each cluster, may combine clusters having the same members (e.g., clusters 312a, 312b), and may display only one representative cluster for each set of duplicate clusters.

In the example illustrated in FIG. 3A, the distance threshold value may be relatively short as indicated on the slider input interface 314. In some embodiments, a shorter distance threshold value may be useful in identifying comparatively smaller clusters of computing devices because responding devices will only report devices that are relatively close. On the other hand, by sending a longer distance threshold value to responding devices, a requesting device may cause the responding devices to identify more of the nearby computing devices, enabling the requesting device to identify larger clusters of computing devices.

FIG. 3B illustrates an example system 320 in which a requesting device (e.g., the requesting device 301 of FIG. 3A) requests grouping information from responding devices 302a-302c regarding nearby devices that are within a relatively long distance threshold value of the responding devices. As described above, the requesting device 301 may use the received grouping information to identify or determine one or more clusters of nearby computing devices.

In the example illustrated in FIG. 3B, the requesting device 301 has determined a distance threshold value—such as based on a position of a slider input interface 314 set by a user—that is greater than the distance threshold value shown in the example illustrated in FIG. 3A. For example, the user of the requesting device 301 may desire to message more computing devices, and thus may input a relatively large distance threshold value, which may cause the requesting device 301 ultimately to identify clusters of computing devices that include more devices (e.g., in comparison to the example illustrated in FIG. 3A). The requesting device 301 may send the determined distance threshold value and a request for grouping information to each of the responding devices 302a-302c via the wireless connections 308a (e.g., as described above with reference to FIG. 3A).

In response to receiving the distance threshold value, the responding devices 302a-302c may determine/identify the computing devices that are within that threshold as described above. In the example illustrated in FIG. 3B, the first responding device 302a may receive signaling and/or messaging from the second responding device 302b and, based on the signaling/messaging, may determine that the second responding device 302b is closer than the distance threshold (i.e., within a perimeter 322a). The first responding device 302a may report to the requesting device 301 that two computing devices (including itself and excluding the requesting device 301) are within the distance threshold.

The second responding device 302b may similarly determine that the first and third responding devices 302a, 302c are closer than the distance threshold (i.e., within a perimeter 322b) based on signals and/or messaging respectively received from those devices over wireless connections 308b, 308c, and the second responding device 302b may report to the responding device that three computing devices (including itself and excluding the requesting device 301) are within the distance threshold. In comparison with the example illustrated in FIG. 3A, the second responding device 302b may determine that comparatively more computing devices are within the distance threshold and, thus, may report a higher number to the requesting device 301.

The third responding device 302c may identify that the second responding device 302b and another computing device 304 are closer than the distance threshold (i.e., within a perimeter 322c) based on signaling and/or messages received via wireless connections 308c, 308d. In response, the third responding device 302c may report to the requesting device 301 that three computing devices (i.e., the responding devices 302b-302c and the other computing device 304) are within the distance threshold. The other computing device 304 may not be directly in communication with the requesting device 301, for example because the requesting device 301 and computing device 304 are out of communication range. Nevertheless, the other computing device 304 may be within the threshold distance of the third responding device 302c, and thus may be identified and reported to the requesting device 301.

Based on the reported numbers of devices within the distance received from the responding devices 302a-302c (as summarized in table 326 illustrated in FIG. 3B), the requesting device 301 may determine that there are three distinct clusters of computing devices corresponding with the reports from each of the responding devices 302a-302c and may display them on a display panel (e.g., the touchscreen display 226). In the example illustrated in FIG. 3B, a first cluster 324a that includes two computing devices corresponding the first and second responding devices 302a, 302b, a second cluster 324b that includes three computing devices corresponding to the first, second, and third responding devices 302a-302c, and a third cluster 324c that includes three computing devices corresponding to the second and third responding devices 302b, 302c and the other computing device 304. As described above, the displayed clusters 324a-324c may include representations of the respective members of the clusters 324a-324c, and these representations may be positioned and/or oriented according to various configurations.

In some embodiments, the requesting device 301 may receive a user input selecting one of the displayed clusters 324a-324c (e.g., as a user input on the touch screen display), and in response, the requesting device 301 may send a message, command, or other signal to the computing devices in the selected cluster. In some particular embodiments in which a selected cluster includes a computing device that is out of communication range of the requesting device 301, the requesting device 301 may communicate indirectly with the out-of-range computing device. For example, the requesting device 301 may send a message intended for the computing device 304 to the third responding device 302c, and the third responding device 302c may forward the message to the computing device 304 on behalf of the requesting device 301 and may forward a response from the computing device 304 to the requesting device 301.

FIG. 3C illustrates an example system 340 in which a requesting device 301 requests from responding devices 342a-342c grouping information regarding nearby devices and additional, descriptive information that may enable the requesting device to more accurately determine one or more clusters of computing devices and identify the computing devices within those clusters. In various embodiments, the requesting device 301 may use the received grouping information and descriptive information (e.g., sensor information, location information, status information, etc.) to identify or determine one or more nearby clusters of computing devices.

In the example illustrated in FIG. 3C (and as described with reference to FIG. 3B), the requesting device 301 may determine a distance threshold value and send a request for grouping information and the determined distance threshold value to each of responding devices 342a-342c via wireless connections 360a. In some embodiments, the request for grouping information may also include a request for descriptive information for the nearby computing devices that includes various types of sensor data, location information, status data, etc. that may help the requesting device 301 determine the particular computing devices that belong in a cluster. The requesting device may also request additional information about the computing devices with a cluster that may enable the requesting device 301 to display or present more accurate indications of the devices' location, current operations, and other information to assist the requesting device's user to visually match the displayed cluster with the devices the user sees in the vicinity.

A first responding device 342a may detect computing devices within the distance threshold (e.g., within a perimeter 346a), such as by receiving signals and/or communications from a second responding device 342b via a wireless connection 360b.

In some embodiments, in response to receiving a request for information from a responding device, a computing device may send to the responding device information including various types of descriptive information. Examples of such descriptive information include its current location (e.g., GPS coordinates), its movement data (e.g., accelerometer, gyroscopic, and compass data), its sensor data (e.g., light-meter readings and camera information), and operational status information (e.g., its device-type and whether it is on an active data or voice call). Thus, in the example illustrated in FIG. 3C, the first responding device 342a may query the second responding device 342b for descriptive information for use by the requesting device 301, and the second responding device 342b may respond with descriptive information indicating the responding device 342b's device type (i.e. that the second responding device 342b is a washing machine).

The first responding device 342a may report the determined number of computing devices within the distance threshold (i.e., the first and second responding devices 342a, 342b) to the requesting device 301. The first responding device 342a may also send descriptive information received from other responding devices (e.g., the device type of the second responding device 342b), as well as its own descriptive information (e.g., a current compass reading 362) to the requesting device 301.

In response to receiving grouping information indicating the reported number of computing devices (e.g., as summarized in the table 358 illustrated in FIG. 3C) and the additional, descriptive information from the first responding device 342a, the requesting device 301 may determine that there is a cluster 352a of two computing devices, that one computing device within the cluster 352a is facing a particular direction (e.g., based on the compass reading 362), and that the other computing device within the cluster 352a is a washing machine The requesting device 301 may display the computing devices within the cluster 352a. The requesting device 301 may also display descriptive information associated with the computing device within the cluster, such as by indicating that one computing device is facing a direction consistent with the compass reading 362 and that the other computing device is a washing machine in the example illustrated in FIG. 3C.

In response to receiving the distance threshold value from the requesting device 301, the second responding device 342b may similarly determine that the first and third responding devices 342a, 342c are closer than the distance threshold (e.g., within a perimeter 346b) and may request and receive descriptive information (e.g., location, status, sensor, etc. information) from the first and third responding device 342a, 342c. In the example illustrated in FIG. 3C, the second responding device 342b may receive the compass reading 362 from the first responding device 342a and my receive status information 364 from the third responding device 342c indicating that the third responding device 342c is currently engaged in a voice call. As summarized in the table 358, the second responding device 342b may report information to the requesting device 301 grouping indicating that three computing devices are within the distance threshold (i.e., the responding device 342a-342c). The second responding device 342b may also send to the requesting device 301 the compass measurement 362 of the first responding device 342a, its device type (e.g., a washing machine), and the status information 364 of the third responding device 342c. The requesting device 301 may utilize the information received from the second responding device 342b to determine that there is a cluster 352b of three computing devices, that one of the computing devices is oriented with respect the compass reading 362, that another computing device is a washing machine, and that yet another computing device is currently engaged in an active voice call based on the status information 364.

Similarly, the third responding device 342c may perform the same or like operations in response to receiving the request for grouping information and the distance threshold value from the requesting device 301. As a result, the third responding device 342a may report grouping information indicating that two computing devices (e.g., the first and second responding devices 342b, 342c) are within the distance threshold (e.g., within a perimeter 346c around the third responding device 342c) and may report additional descriptive information related to the devices within the distance threshold (e.g., the status information 364 and that the second responding device 342b is a washing machine) On receiving this information from the third responding device 342c, the requesting device 301 may determine that there is a cluster 352c of two computing devices, that one of the computing devices is a washing machine, and that the other computing device is on an active voice call. The requesting device 301 may display the cluster 352c, along with an indication that one computing device within the cluster 352c is a washing machine and that the other computing device within the cluster 352c is on a voice call (as illustrated by a telephone icon).

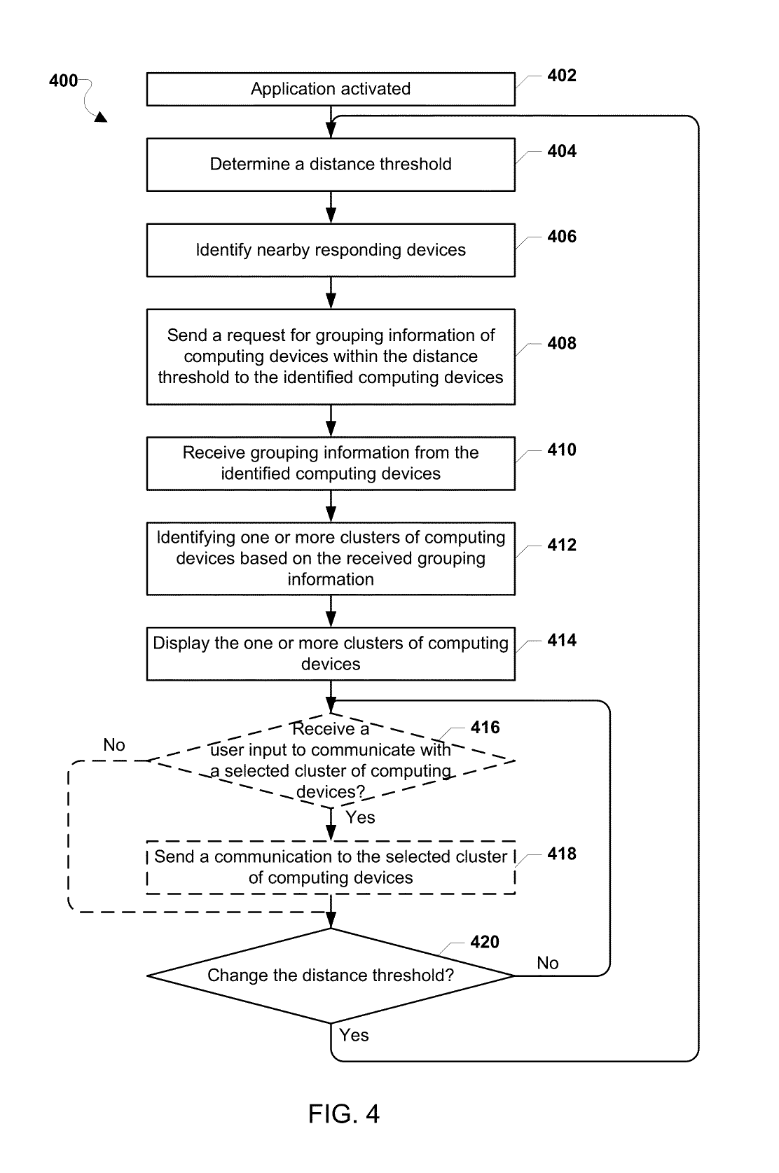

FIG. 4 illustrates an embodiment method 400 that may be implemented by a device processor of a requesting device for determining one or more clusters of computing devices based on grouping information received from one or more responding devices. The method 400 may be implemented with a processor (e.g., the general processor 206 of FIG. 2, the baseband modem processor 216, a separate controller, and/or the like) of a computing device (such as the computing devices 110, 200, and 301 described with reference to FIGS. 1-3). The device processor may perform the operations of the method 400 in response to when an application implementing the method 400 is activated in block 402. Such an application may include activating or logging on to a common communication application (e.g., Aljoyn®).

In block 404, the device processor may determine a distance threshold that may be a value determined by and/or received as a user input to the requesting device and that may represent a particular distance value (e.g., as indicated by a RSSI value, a Bluetooth® antenna gain, a physical distance based on GPS coordinates, etc.). In various embodiments, the distance threshold may be selected in order to limit the size or number of computing devices included in identified clusters (e.g., as described above with reference to FIGS. 3A-3B).

In block 406, the device processor may identify one or more responding devices that are nearby, such as by monitoring for signals, communications, and/or messages sent from those devices. In some embodiments, the device processor may monitor for wireless transmissions sent from nearby responding devices via a common communication application.

In block 408, the device processor may send a request for grouping information of computing devices within the distance threshold determined in block 404 to the responding devices identified in block 406. In some embodiments, the device processor may include the distance threshold in the request for grouping information or, alternatively, may send the distance threshold to the identified responding devices in a separate message.

In block 410, the device processor may receive grouping information from the responding devices identified in block 406. As described (e.g., with reference to FIGS. 3A-3C), grouping information may include various types of information and data that may enable the device processor on the requesting device to determine whether one or more clusters of computing devices are within the vicinity of each responding device. In some embodiments, the grouping information may indicate a number of computing devices that are within the distance threshold value of each responding device. In some embodiments (e.g., with reference to FIG. 5), the grouping information received from the one or more responding devices may additionally include descriptive information, such as data and/or information that the device processor may use to determine the characteristics, orientation, and/or location of members of a cluster of computing devices.

Based on the grouping information received in block 410, the device processor may identify one or more clusters of computing devices in block 412. In some embodiments, the device processor may identify a cluster of computing devices based on grouping information received from each responding device. In other words, the device processor may generate a cluster of computing devices that corresponds to the specific grouping information sent by a particular responding device. For example, the device processor may determine that there are three clusters of computing devices in response to receiving grouping information from three responding devices. In some embodiments, the device processor may identify only unique clusters of computing devices by removing redundant grouping information. For example, the device processor may determine that two responding devices are very likely reporting information regarding the same computing devices, and as a result, the device processor may determine that there is only one cluster despite receiving reports from two different responding devices.

In block 414, the device processor may display the one or more clusters of computing devices determined in block 412. In some embodiments, a displayed cluster may individually depict each member of that cluster, as well as any identifying information that may assist the user in matching the displayed cluster with the computing devices the user may actually see in the vicinity.

In optional determination block 416, the device processor may determine whether it has received a user input to communicate with a selected cluster of computing devices. In some embodiments, the requesting device may receive a user input (e.g., via the touchscreen display 226 and/or another user interface mechanism) selecting one (or more) of the clusters of computing devices displayed in block 414. In response to determining that a user input to communicate with a selected cluster of computing devices has been received on the requesting device (i.e., optional determination block 416=“Yes”), the processor device may optionally send a communication to each member of the selected cluster devices in optional block 418. In some embodiments, the device processor may send one or more messages, signals, commands, etc. to each member of the selected cluster of computing devices via a common communication application (e.g., AllJoyn®), thereby ensuring that each member may receive and process the messages sent from the requesting device without regard to the type, brand, model, etc. of the requesting device.

In response to determining that a user input to communicate with a selected cluster of computing devices has not been received on the requesting device (i.e., optional determination block 416=“No”) or in response to sending a communication to the selected cluster of computing devices in optional block 418, the device processor may determine whether to change the distance threshold in determination block 420. In some embodiments, the device processor may determine whether a new user input specifying a different distance threshold value has been received. For example, the device processor may determine that a smaller device threshold value has been received via a user input, which may reflect the user's desire to communicate with smaller clusters of computing devices.

In response to determining not to change the distance threshold (i.e., determination block 420=“No”), the device processor may repeat the operations of optional determination block 416 in a loop awaiting a user input. In response to determining to change the distance threshold (i.e., determination block 420=“Yes”), the device processor may determine a new distance threshold value in block 404 and may continue performing the operations of the method 400 as described above.

FIG. 5 illustrates an embodiment method 500 that may be implemented by a device processor of a requesting device for determining one or more clusters of computing devices based on descriptive information (e.g., location information, sensor information, and/or status information) received from one or more responding devices. The method 500 may be implemented with a processor (e.g., the general processor 206 of FIG. 2, the baseband modem processor 216, a separate controller, and/or the like) of a computing device (such as the computing devices 110, 200, and 301 described with reference to FIGS. 1-3). The operations of the method 500 may implement embodiments of the operations performed in blocks 410-414 of the method 400 described above with reference to FIG. 4. Thus, the device processor may begin performing the operations of the method 500 after requesting grouping information from one or more responding devices in block 410 of the method 400.

As described above, the device processor on the requesting device may utilize various types of information related to a computing device when determining/identifying a cluster of computing devices. For example, the device processor may utilize such descriptive information related to computing devices' location, characteristics, orientation, operations, etc. to more accurately identify a cluster of computing devices. The device processor may also utilize the descriptive information to display an indication of the location, orientation, and/or current activities of members of an identified cluster, thereby increasingly the likelihood that a user of the requesting device may be able to visually match the computing devices in a displayed cluster with devices operating in the vicinity.

In block 502, the device processor may receive descriptive information from one or more responding devices identified in block 406 of method 400 regarding computing devices within the distance threshold value of the one or more identified responding devices. In some embodiments, the descriptive information may include at least one of location information, sensor information, and status information. As described (e.g., with reference to FIG. 3C), the descriptive information may include various types of data or information that may indicate the relative or absolute location of a computing device and/or the movement characteristics of that computing device. For example, location information may indicate that a computing device is located at a particular GPS coordinate and that the computing device's accelerometer is reporting forward movement that is corroborated by a compass measurement taken on the computing device. The descriptive information may also or alternatively include various other types of information specific to each computing device within the distance threshold of the one (or more) identified responding devices, such as their current operating status (e.g., conducting a data call/Internet session).

In block 504, the device processor may identify one or more clusters of computing devices based on the grouping information received in block 410 of the method 400 and based on the received descriptive information received in block 504. As described above, the device processor may utilize the grouping information to identify one or more unique (i.e., not redundant or duplicated) clusters of computing devices. In some embodiments, the device processor may compile all of the information received from each responding device to determine/identify one or more unique clusters based at least in part on the received descriptive information. In such embodiments, the device processor may determine whether two or more responding devices are effectively reporting the same cluster of computing devices (i.e., a cluster with the same members) by comparing particular identifying information for each reporting or reported computing device. For example, based on compass readings and GPS coordinates of computing devices reported to be within the distance threshold of two responding devices, the device processor may determine that the two responding devices are reporting the same computing devices and, thus, that only one cluster of computing devices is necessary to represent those computing devices. In other words, the device processor may determine that there is only one cluster of computing devices in situations in which multiple sets of information indicate that multiple clusters include the same members.

In block 506, the device processor may display the one or more clusters of computing devices based on the received grouping information and based on the received descriptive information. In some embodiments, the device processor may display each computing device within a cluster of computing devices to accurately reflect their relative or absolute position as determined based on the descriptive information for those computing devices as received in block 502. For example, a computing device within a cluster may be oriented on a display of the requesting device in a direction consistent with a compass measurement associated with that computing device.

In some embodiments, the device processor may also annotate or otherwise present descriptive information (e.g., location, sensor, and/or status information) associated with each computing device within a cluster of computing devices. For example, the device processor may depict a computing device within a cluster using a particular icon representing the device's current status or state of operation (e.g., a telephone icon to indicate that the computing device is currently engaged in an active voice call as described with reference to FIG. 3C). By presenting this additional information describing the various characteristics of each computing device within a cluster to the user, the device processor may increase the likelihood that the user will be able to match a displayed cluster of computing devices with the computing devices that are visible in the vicinity.

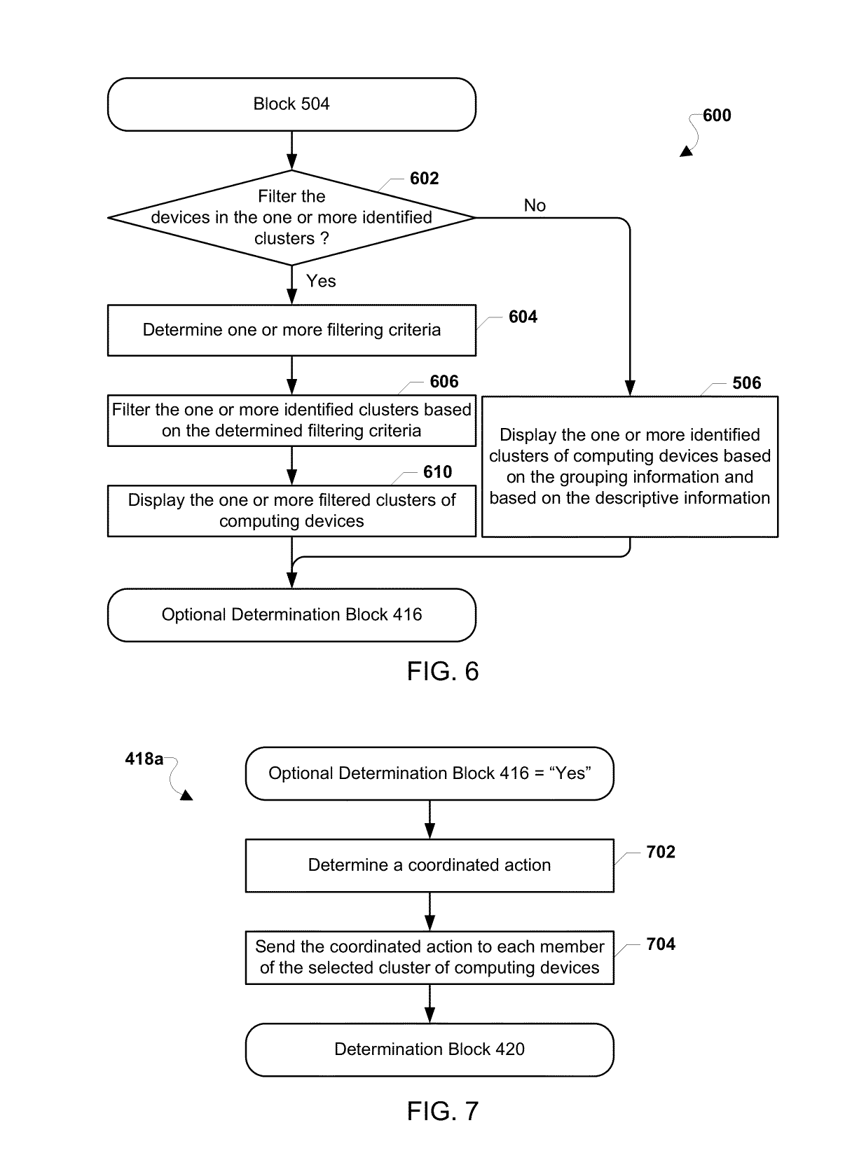

The device processor may continue by determining whether a user input to communicate with the selected cluster of computing devices has been received on the requesting device in optional determination block 416 of the method 400. In other embodiments, the device processor may continue by executing method 600 as described below with reference to FIG. 6.

FIG. 6 illustrates an embodiment method 600 that may be implemented by a device processor of a requesting device for displaying one or more filtered clusters of computing devices. The method 600 may be implemented with a processor (e.g., the general processor 206 of FIG. 2, the baseband modem processor 216, a separate controller, and/or the like) of a computing device (such as the computing devices 110, 200, and 301 described with reference to FIGS. 1-3). The operations of the method 600 may implement embodiments of the operations performed in block 506 of the method 500 described above with reference to FIG. 5. Thus, the device processor may begin performing the operations of the method 600 in response to identifying one or more clusters of computing devices based on grouping information and descriptive information (e.g., location, sensor, and/or status information) in block 504 of method 500.

In determination block 602, the device processor may determine whether to filter computing devices in the one or more clusters of computing devices identified in block 504 of the method 500, such as by determining whether a user input has been received that specifies that only a certain type of computing device may be displayed. In other words, the device processor may anticipate or respond to a user's preferences when selecting the computing devices within a cluster of computing devices that will be displayed to the user. In response to determining not to filter the computing devices included in the one or more identified clusters of computing devices (i.e., determination block 602=“No”), the device processor may display the one or more clusters of computing devices based on the grouping information and based on the descriptive information (e.g., location, sensor, and/or status information) received in block 502 of method 500 as described above with reference to FIG. 5.

In response to determining that the processor should filter the devices included in the one or more clusters of computing devices (i.e., determination block 602=“Yes”), the device processor may determine one or more filtering criteria in block 604. These filtering criteria may include user preferences received as a user input. For example, a user input may indicate the user's desire to message/see only smart phones (e.g., in contrast to home appliances), and the device processor may determine/identify that “device type” is a filtering criterion to be applied when displaying clusters of computing devices. In another example, the device processor may determine (e.g., based on user input) that only computing devices facing a certain direction may be displayed, which may be determined based on compass measurements associated with each member of a cluster.

In block 606, the device processor may filter the one or more identified clusters of computing devices based on the filtering criteria determined in block 604. In some embodiments, by filtering a cluster of computing devices, the device processor may identify only those computing devices in the cluster that may be displayed. The device processor may also display the one or more filtered clusters of computing devices in block 610, ensuring that only useful or relevant computing devices are displayed to the user. In the above examples, the device processor may display only smart phones or only computing devices facing a certain direction.

Regardless of whether the device processor displays filtered clusters of computing devices in block 610 or displays unfiltered clusters in block 506, the device processor may continue in optional determination block 416 of the method 400 by determining whether a user input to communicate with a selected cluster computing devices has been received on the requesting device.

FIG. 7 illustrates an embodiment method 418a that may be implemented by a device processor of a requesting device for sending coordinated actions to members of a selected cluster of computing devices. The method 700 may be implemented with a processor (e.g., the general processor 206 of FIG. 2, the baseband modem processor 216, a separate controller, and/or the like) of a computing device (such as the computing devices 110, 200, and 301 described with reference to FIGS. 1-3). The operations of the method 418a may implement embodiments of the operations performed in optional block 418 of the method 400 described above with reference to FIG. 4. Thus, the device processor may begin performing the operations of the method 418a in response to determining that a user input to communicate with a selected cluster of computing devices has been received on the requesting device (i.e., optional determination block 416=“Yes”).

In block 702, the device processor may determine a coordinated action, which may be a command or other signaling that may be used to configure each member of the selected cluster of computing devices to perform an action simultaneously. In some embodiments, the device processor may determine the coordinated action based on a user input received on the requesting device. For example, the coordinated action may include a command to configure each member of the selected cluster of computing devices to play a sound at the same time. Prompting all computing devices in a cluster may be useful in grabbing the attention of the users of the computing devices in the selected cluster because when each device plays the sound it will be more difficult to miss (or ignore) than if only one computing device played the sound. In another example, the coordinated action may be related to displaying a message, initiating some function, activating a shaker, etc. on each member of the selected cluster.

In block 704, the device processor may send the coordinated action request to each member of the selected cluster of computing devices, such as via a common communication application. In some embodiments (not shown), in response to receiving the coordinated action, each member may perform the coordinated action at the same time. The device processor may determine whether to change the distance threshold value in determination block 420 of method 400 as described above with reference to FIG. 4.

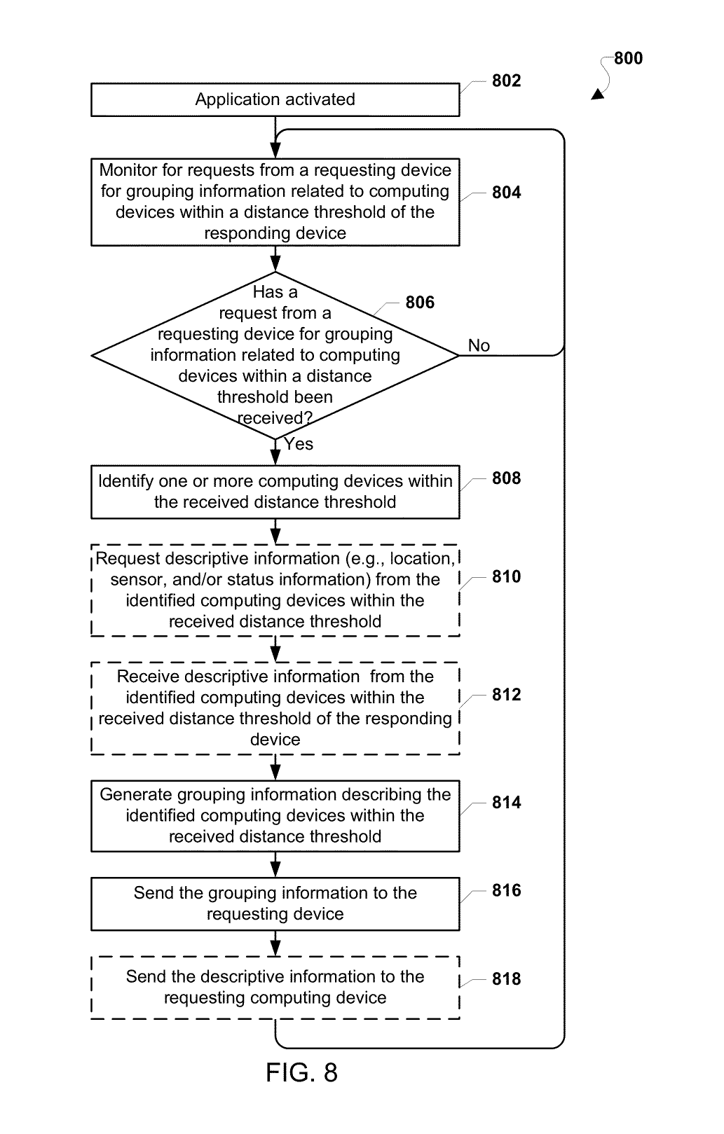

FIG. 8 illustrates an embodiment method 800 that may be implemented by a device processor of a responding device for generating group information describing computing devices that are within a certain distance threshold value of the responding device. The method 800 may be implemented with a processor (e.g., the general processor 206 of FIG. 2, the baseband modem processor 216, a separate controller, and/or the like) of a computing device (such as the computing devices 110, 200, 301, 302a-302c, and 342a-342-c described with reference to FIGS. 1-3). The device processor may begin performing the operations of the method 800 in response to an application implementing the method being activated in block 402. Such an application may include activating or logging on to a common communication application (e.g., Aljoyn®).

In block 804, the device processor on the responding device may monitor a communication channel for requests from a requesting device for grouping information related to computing devices within a distance threshold of the responding device. In some embodiments, the responding device may monitor a public port associated with a common communication application for requests for grouping information. As described above, a responding device may collect grouping information about computing devices within a certain area around the responding device as defined by a distance threshold value received from a requesting device. In other words, a requesting device may rely on the responding device to identify and report information regarding computing devices in the area that may be displayed on the requesting device as a cluster of computing devices.

In determination block 806, the device processor may determine whether a request from a requesting device for grouping information related to computing devices within a distance threshold value of the responding device has been received. In response to determining that a request for grouping information has not been received (i.e., determination block 806=“No”), the device processor may continue monitor a communication channel for requests from a requesting device in block 804.

In response to determining that a request for grouping information related to computing devices within a distant threshold has been received from a requesting device (i.e., determination block 806=“Yes”), the device processor may identify one or more computing devices within the received distance threshold of the responding device in block 808. In some embodiments, the received distance threshold value may be represented as a minimum RSSI value. In such embodiments, the device processor may identify only those computing devices around the responding device whose signals have an RSSI value that is equal to or greater than the RSSI value associated with the received distance threshold. In another example, the device processor may use the distance threshold to adjust a Bluetooth® antenna's gain, ensuring that the responding device is only able to communicate with (or detect) devices that are within the received distance threshold value.

In optional block 810, the device processor may request descriptive information (e.g., location, sensor, and/or status information) from the computing devices identified in block 808 (i.e., from computing devices that are within the received distance threshold of the responding device). As described, such types of information may be related to various characteristics of the identified computing devices, such as their respective locations, orientations, current operating statuses, etc. The device processor may optionally receive such descriptive information from responding computing devices in optional block 812. In some embodiments, the request and receipt of such information may be conducted via messaging/signaling exchanged between the device processor and the identified computing devices through a common communication application.

In block 814, the device processor may generate grouping information describing the computing devices within the received distance threshold of the responding device identified in block 806, such as by determining the number of identified computing devices within the distance threshold. In some embodiments, the grouping information may include details related to the responding device. For example, the number of devices within the threshold value may include the responding device.

The device processor may send the grouping information to the requesting device in block 816, such as via messaging sent with a common communication application, and the requesting device may use the grouping information to determine a cluster of computing devices. In optional embodiments, the device processor may also send the descriptive information (e.g., the location, sensor and/or status information) to the requesting computing device in optional block 818, thereby enabling the requesting device to distinguish between the identified computing devices represented in the grouping information and/or to display the identified computing devices based on the descriptive information (e.g., as described above with reference to FIGS. 5-6).

The device processor may repeat the above operations in a loop by again monitoring for the next request from a requesting device for grouping information related to computing devices within some distance threshold of the responding device in block 804.

The various embodiments may be implemented using a common communication application that enables messaging exchanges between computing devices without revealing addressing or personal information of the respective users. Because the clustering of computing devices is based on separation distances, no device addresses need to be exchanged beyond those required by the common communication protocol, which may be anonymous (e.g., based on random or ad hoc identifiers). Also, the additional information requests related to compass bearings, acceleration, call state, etc. may be anonymous and not reveal personal information of the respective user, because such information is only of use to someone present to see the physical manifestation of such information (e.g., where a computing device is pointing or whether a user is talking on their smart phone).

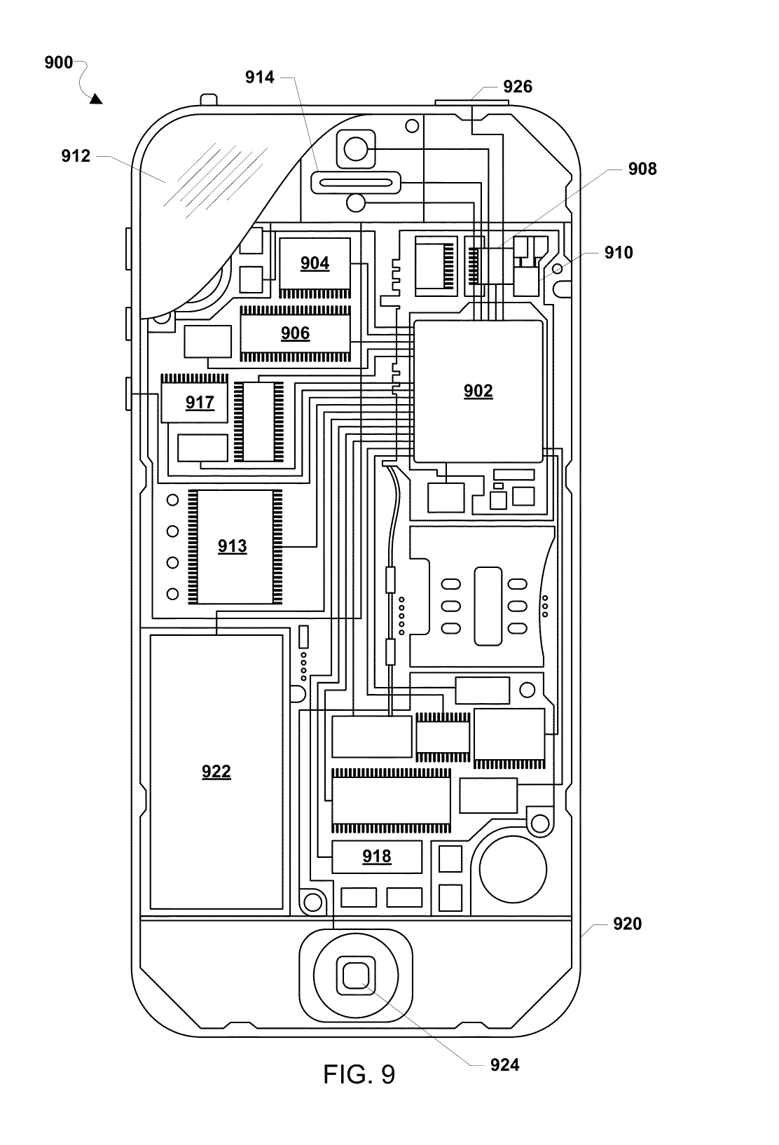

Various embodiments methods may be implemented in any of a variety of computing devices, an example on which (e.g., computing device 900) is illustrated in FIG. 9. According to various embodiments, the computing device 900 may be similar to the computing devices 110, 120, 200 as described above with reference to FIGS. 1-2.

The computing device 900 may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the computing device 900 need not have touch screen capability.

The computing device 900 may have a cellular network transceiver 908 coupled to the processor 902 and to an antenna 910 and configured for sending and receiving cellular communications. The transceiver 908 and the antenna 910 may be used with the above-mentioned circuitry to implement the various embodiment methods. The computing device 900 may include a SIM card 913 coupled to the transceiver 908 and/or the processor 902 and configured as described above. The computing device 900 may include a cellular network wireless modem chip 917 that enables communication via a cellular network and is coupled to the processor 902.

The computing device 900 may also include speakers 914 for providing audio outputs. The computing device 900 may also include a housing 920, constructed of a plastic, metal, or a combination of materials, for containing all or some of the components discussed herein. The computing device 900 may include a power source 922 coupled to the processor 902, such as a disposable or rechargeable battery. The rechargeable battery may also be coupled to the peripheral device connection port to receive a charging current from a source external to the computing device 900. The computing device 900 may also include a physical button 924 for receiving user inputs. The computing device 900 may also include a power button 926 for turning the computing device 900 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, will modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of identifying a cluster of computing devices by a requesting device, comprising:
determining, on the requesting device, a distance threshold for defining a cluster;
sending the distance threshold and a request for grouping information from the requesting device to a responding device;
receiving, on the requesting device, grouping information from the responding device indicating a number of computing devices within the distance threshold of the responding device; and
identifying, on the requesting device, a cluster of computing devices based on received grouping information.

2. The method of claim 1, further comprising presenting a display of the cluster of computing devices on a display screen of the requesting device.

3. The method of claim 2, wherein presenting a display of the cluster of computing devices on a display screen of the requesting device comprises:
determining a filtering criterion;
filtering computing devices within the cluster of computing devices based on the determined filtering criterion; and
presenting a display on the display screen of the requesting device that includes only the filtered computing devices.

4. The method of claim 1, further comprising:
receiving a user input selection of the cluster of computing devices; and
sending a communication to each computing device within the selected cluster of computing devices.

5. The method of claim 4, wherein sending a communication to each computing device within the selected cluster of computing devices comprises sending a request to each computing device within the selected cluster of computing devices to perform a coordinated action.

6. The method of claim 1, further comprising receiving descriptive information from the responding device describing the number of computing devices within the distance threshold of the responding device, wherein identifying, on the requesting device, a cluster of computing devices based on the received grouping information comprises identifying the cluster of computing devices based on the grouping information and received descriptive information.

7. The method of claim 6, further comprising presenting a display on a display screen of the requesting device of the cluster of computing devices based on the received descriptive information.

8. A requesting device, comprising:
a processor configured with processor-executable instructions to perform operations comprising:
determining a distance threshold for defining a cluster;
sending the distance threshold and a request for grouping information from the requesting device to a responding device;
receiving grouping information from the responding device indicating a number of computing devices within the distance threshold of the responding device; and
identifying a cluster of computing devices based on the received grouping information.

9. The requesting device of claim 8, wherein the processor is configured with processor-executable instructions to perform operations further comprising presenting a display of the cluster of computing devices on a display screen of the requesting device.

10. The requesting device of claim 9, wherein the processor is configured with processor-executable instructions to perform operations such that presenting a display of the cluster of computing devices on a display screen of the requesting device comprises:
determining a filtering criterion;
filtering computing devices within the cluster of computing devices based on the determined filtering criterion; and
presenting a display on the display screen of the requesting device that includes only the filtered computing devices.

11. The requesting device of claim 8, wherein the processor is configured with processor-executable instructions to perform operations further comprising:
receiving a user input selection of the cluster of computing devices; and
sending a communication to each computing device within the selected cluster of computing devices.

12. The requesting device of claim 11, wherein the processor is configured with processor-executable instructions to perform operations such that sending a communication to each computing device within the selected cluster of computing devices comprises:
sending a request to each computing device within the selected cluster of computing devices to perform a coordinated action.

13. The requesting device of claim 8, wherein the processor is configured with processor-executable instructions to perform operations further comprising receiving descriptive information from the responding device describing the number of computing devices within the distance threshold of the responding device,
wherein the processor is configured with processor-executable instructions to perform operations such that identifying a cluster of computing devices based on the received grouping information comprises identifying the cluster of computing devices based on the grouping information and received descriptive information.

14. The requesting device of claim 13, wherein the processor is further configured with processor-executable instructions to perform operations comprising presenting a display on a display screen of the requesting device of the cluster of computing devices based on the received descriptive information.

15. A method implemented on a responding device for identifying nearby computing devices, comprising:
receiving, on the responding device, a distance threshold from a requesting device;
identifying, on the responding device, any computing devices within the distance threshold of the responding device; and
sending to the requesting device information regarding identified computing devices within the distance threshold of the responding device.

16. The method of claim 15, wherein sending to the requesting device information regarding identified computing devices within the distance threshold of the responding device comprises:
generating, on the responding device, grouping information indicating a number of computing devices within the distance threshold of the responding device; and
sending the grouping information from the responding device to the requesting device.

17. The method of claim 15, further comprising:
requesting descriptive information from the identified computing devices within the distance threshold of the responding device;
receiving, on the responding device, descriptive information from the identified computing devices; and
sending the received description information from the responding device to the requesting device.

18. A responding device, comprising:
a processor configured with processor-executable instructions to perform operations comprising:
receiving a distance threshold from a requesting device;
identifying any computing devices within the distance threshold of the responding device; and
sending to the requesting device information regarding identified computing devices within the distance threshold of the responding device.

19. The responding device of claim 18, wherein the processor is configured with processor-executable instructions to perform operations such that sending to the requesting device information regarding identified computing devices within the distance threshold of the responding device comprises:
generating grouping information indicating a number of computing devices within the distance threshold of the responding device; and
sending the grouping information from the responding device to the requesting device.

20. The responding device of claim 18, wherein the processor is configured with processor-executable instructions to perform operations further comprising:
requesting descriptive information from the identified computing devices within the distance threshold of the responding device;
receiving descriptive information from the identified computing devices; and
sending the received description information from the responding device to the requesting device.
